(19) United States
(12) Patent Application Publication
(10) Pub. No.: US 2024/0037685 A1
(43) Pub. Date: Feb. 1, 2024

(54) Detecting Suboptimal Performance of Security Check Operations

(71) Applicant: Athena Security, Inc., Austin, TX (US)

(72) Inventor: Christopher Carlo Ciabarra, Austin, TX (US)

(73) Assignee: Athena Security, Inc., Austin, TX (US)

(21) Appl. No.: 18/357,905

(22) Filed: Jul. 24, 2023

Related U.S. Application Data
(60) Provisional application No. 63/369,375, filed on Jul. 26, 2022.

(51) Int. Cl. G06Q 50/26; G01S 13/88

(52) U.S. Cl. CPC G06Q 50/265; G01S 13/887

(57) ABSTRACT

A system for detecting suboptimal performance of security check operations. The system may include a sensor operable to output sensor data indicative of physical characteristics of a security check environment, an output device, and a processing device comprising a processor and a memory. The security check environment may include at least one of a prohibited object detector, a human patron, an object carried by the human patron, and a human security officer. The processing device may be operable to: determine, based on the sensor data, that security check operations at the security check environment are being performed in a suboptimal manner; and in response to determining that the security check operations are being performed in a suboptimal manner, output alarm data to the output device to cause the output device to output an alarm signal indicative of the suboptimal manner in which the security check operations are being performed.

### CROSS-REFERENCE TO RELATED APPLICATIONS

This application claims priority to and the benefit of U.S. Provisional Application No. 63/369,375, titled “ALERT ON HUMAN ERRORS WHILE USING OR OPERATING A METAL DETECTOR,” filed Jul. 26, 2022, the entire disclosure of which is hereby incorporated herein by reference.

### BACKGROUND OF THE DISCLOSURE

A security check environment can be implemented at entrance points of office buildings, government buildings, courthouses, mass transportation terminals (e.g., airports, train stations, bus stations, etc.), convention centers, stadiums, casinos, stores, schools, hospitals, and other buildings or spaces where security checks of human patrons are performed by prohibited object detectors and/or human security officers. A security check environment may comprise a prohibited object detector operable to detect a potentially prohibited object (e.g., a metal object, a sharp object, a dense object, a large object, etc.), one or more human security officers stationed near the prohibited object detector, one or more human patrons (e.g., employees, visitors, travelers, spectators, vacationers, shoppers, students, etc.) who intend to walk through the prohibited object detector to gain access to their intended destination, one or more barriers (e.g., fencing, railing, walls, etc.) for limiting movement of the human patrons and directing the human patrons toward and through the prohibited object detector, one or more objects (e.g., handbags, backpack, wallets, box containers, etc.) carried by the human patrons, and/or one or more security tables for supporting the carried objects such that they can be examined by the human security officers.

During security check operations, a prohibited object detector may be used to check (or scan) human patrons for prohibited objects (e.g., firearms, knives, explosives, etc.) by detecting potentially prohibited objects carried by the human patrons. The potentially prohibited objects may be carried openly or in a concealed manner within a carried object by a human patron as the human patron walks through the prohibited object detector to his or her intended destination. When the prohibited object detector detects a potentially prohibited object, the prohibited object detector may output an audio and/or visual alarm. In response to the alarm, a human security officer may instruct the human patron to walk back through the prohibited object detector, and then perform an additional security check of the human patron and/or the object carried by the human patron. For example, a human security officer may physically check (e.g., open) the carried object or physically check the human patron (e.g., execute a pat down, scan with a handheld metal detector, request to empty pockets, etc.) in an attempt to find or otherwise identify the potentially prohibited object. When the human security officer finds or identifies the potentially prohibited object, the human security officer may request the human patron to walk again through the prohibited object detector, but without the potentially prohibited object, to check the human patron for additional potentially prohibited objects. When the human patron again passes through the prohibited object detector and the prohibited object detector does not output an audio and/or visual alarm, the human security officer may then permit the human patron to leave the security check environment toward their intended destination.

During security check operations, human security officers may manage the security check operations, such as by operating a prohibited object detector, directing movement of human patrons through a prohibited object detector, and checking human patrons for prohibited objects. However, security check operations may be performed in a suboptimal manner because of erroneous, unintended, improper, deceitful, or otherwise suboptimal actions performed by human patrons and/or human security officers during and/or in preparation for security check operations. Suboptimal performance of security check operations may include a human patron using a prohibited object detector in a suboptimal (e.g., erroneous, deceitful) manner, a human security officer operating or using a prohibited object detector or other security equipment in a suboptimal (e.g., erroneous, unintended, etc.) manner, a human security officer manually performing security check operations on a human patron in a suboptimal (e.g., erroneous, unintended, etc.) manner, and/or a human security officer configuring a prohibited object detector in a suboptimal manner for use during security check operations.

For example, when a prohibited object detector is moved linearly and/or rotated, without a human security officer noticing, a space (or gap) can be formed or become larger with respect to a barrier, permitting a human patron to fit through the space between the prohibited object detector and the barrier, and walk around or otherwise bypass the prohibited object detector, also without a human security officer noticing. Furthermore, when portions of a prohibited object detector are moved linearly (i.e., closer together or further apart) and/or rotated with respect to the other, without a human security officer noticing, a detection area (or space) of the prohibited object detector may contract (i.e., shrink) or otherwise lose its detection effectiveness, thereby permitting a human patron to carry a potentially prohibited object through the prohibited object detector without detection.

### BRIEF DESCRIPTION OF THE DRAWINGS

The present disclosure is understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic view of at least a portion of an example implementation of apparatus according to one or more aspects of the present disclosure.

FIG. 2 is a schematic view of at least a portion of an example implementation of apparatus according to one or more aspects of the present disclosure.

FIG. 3 is a schematic view of at least a portion of an example implementation of apparatus according to one or more aspects of the present disclosure.

FIG. 4 is a schematic view of at least a portion of an example implementation of apparatus according to one or more aspects of the present disclosure.

FIG. 5 is a schematic view of at least a portion of an example implementation of apparatus according to one or more aspects of the present disclosure.

FIG. 6 is a schematic view of at least a portion of an example implementation of apparatus according to one or more aspects of the present disclosure.

FIG. 7 is a schematic view of at least a portion of an example implementation of apparatus according to one or more aspects of the present disclosure.

FIG. 8 is a schematic view of at least a portion of an example implementation of apparatus according to one or more aspects of the present disclosure.

FIG. 9 is a schematic view of at least a portion of an example implementation of apparatus according to one or more aspects of the present disclosure.

FIG. 10 is a schematic view of at least a portion of an example implementation of apparatus according to one or more aspects of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for simplicity and clarity, and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

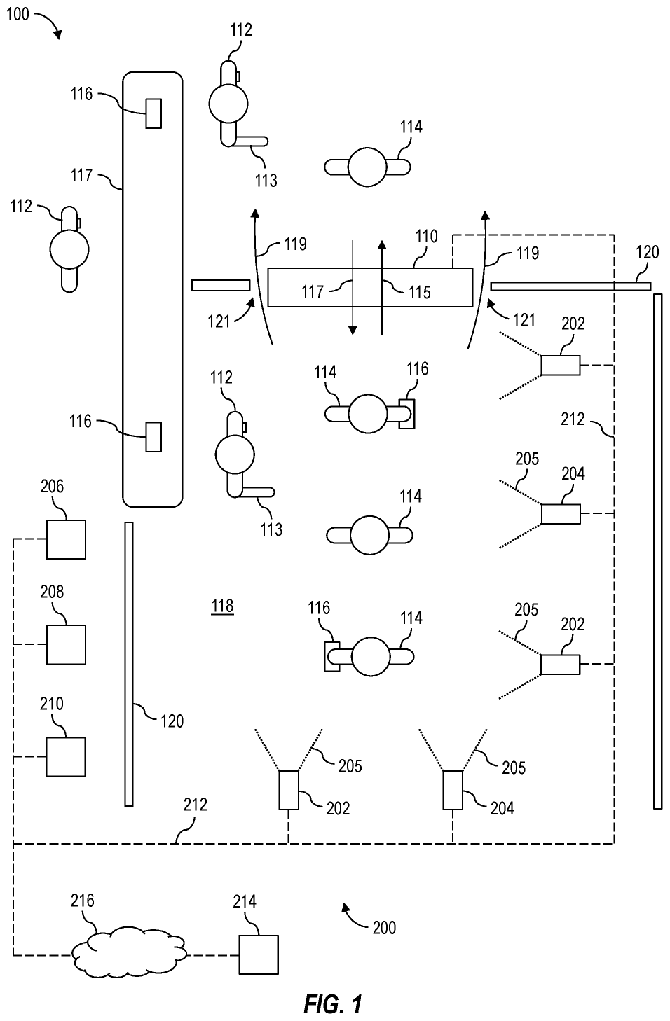

FIG. 1 is a schematic view of at least a portion of an example implementation of a security check environment 100 according to one or more aspects of the present disclosure. The security check environment 100 represents an example environment in which one or more aspects introduced in the present disclosure may be implemented. The security check environment 100 may be or comprise a security check area that can be located at entrance points of office buildings, government buildings, courthouses, mass transportation terminals (e.g., airports, train stations, bus stations, etc.), convention centers, stadiums, casinos, stores, schools, hospitals, and other buildings or spaces where security checks of human patrons are performed by prohibited object detectors and/or human security officers.

The security check environment 100 comprises a prohibited object detector 110, one or more human security officers 112, one or more human patrons 114, one or more barriers 120, one or more objects 116, and/or one or more security tables 117. The prohibited object detector 110 is operable to detect a potentially prohibited object (e.g., a metal object, a sharp object, a dense object, a large object, firearms, knives, explosives, etc.). The prohibited object detector 110 may be or comprise, for example, a metal detector, an X-ray machine, a millimeter wave scanner, a trace portal machine, frequency machine (e.g., a millimeter wave frequency machine, a wi-fi frequency machine, a terra hertz frequency machine, etc.) a radio wave signal machine, and/or a weapons detection system. The one or more human security officers 112 are stationed near the prohibited object detector 110. The one or more human patrons 114 (e.g., employees, visitors, travelers, spectators, vacationers, shoppers, students, etc.) are those who intend to walk through the prohibited object detector 110 to gain access to their intended destination. The one or more barriers 120 (e.g., fencing, railing, walls, etc.) are for limiting movement of the human patrons 114 and directing the human patrons 114 toward and through the prohibited object detector 110. The one or more objects 116 (e.g., handbags, backpack, wallets, box containers, etc.) are carried by the human patrons 114. The one or more security tables 117 are for supporting the carried objects 116 such that they can be examined by the human security officers 112. The prohibited object detector 110, the barriers 120, and the table 117 may be installed or otherwise located on a floor 118 of the security check environment 100.

During security check operations, the prohibited object detector 110 may be used to check (or scan) the human patrons 114 for prohibited objects by detecting potentially prohibited objects carried by the human patrons 114. The potentially prohibited objects may be carried openly or in a concealed manner within a carried object 116 by a human patron 114 as the human patron 114 walks through the prohibited object detector 110 (as indicated by arrow 115) to their intended destination. When the prohibited object detector 110 detects a potentially prohibited object, the prohibited object detector 110 may output an audio and/or visual alarm. In response to the alarm, a human security officer 112 may instruct the human patron 114 to walk back through the prohibited object detector 110 (as indicated by arrow 117) and then perform an additional security check of the human patron 114 and/or the object 116 carried by the human patron 114. For example, a human security officer 112 may physically check (e.g., open) the carried object 116 or physically check the human patron 114 (e.g., execute a pat down, scan with a handheld metal detector 113, request to empty pockets, etc.) in an attempt to find or otherwise identify the potentially prohibited object. When the human security officer 112 finds or identifies the potentially prohibited object, the human security officer 112 may request the human patron 114 to walk through 115 the prohibited object detector 110 again, but without the potentially prohibited object, in order to check the human patron 114 for additional potentially prohibited objects. When the human patron 114 again passes through 115 the prohibited object detector 110 and the prohibited object detector 110 does not output an audio and/or visual alarm, the human security officer 112 may then permit the human patron 114 to leave the security check environment 100 toward their intended destination.

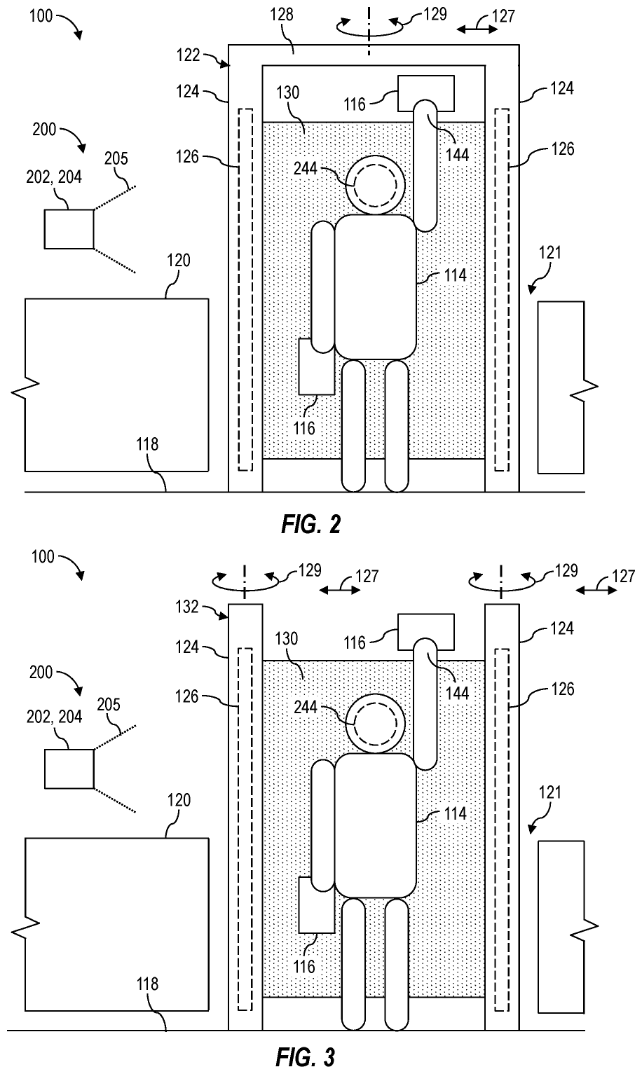

FIGS. 2 and 3 are schematic views of a portion of example implementations of the security check environment 100 shown in FIG. 1 during security check operations. Each of the FIGS. 2 and 3 show a different example implementation of a prohibited object detector 110 that may be located within the security check environment 100. Accordingly, the following description refers to FIGS. 1-3, collectively.

As shown in FIG. 2, the prohibited object detector 110 may be a single-unit (or single-structure) prohibited object detector 122 having vertical portions 124 (e.g., poles, posts, walls, members, etc.), each comprising a prohibited object detection device 126 (shown in phantom lines) operable to detect potentially prohibited objects carried by human patrons 114. The vertical portions 124 may be connected by an upper horizontal portion 128, which may maintain the vertical portions 124 at a predetermined relative separation distance. The detection devices 126 may generate a detection field (e.g., energy field) defining a prohibited object (or weapon) detection area (or space) 130 within which the prohibited object detector 122 can detect potentially prohibited objects. However, when the prohibited object detector 122 is moved linearly, as indicated by arrows 127, and/or rotated, as indicated by arrows 129, a space (or gap) 121 may be formed or become larger with respect to the barrier 120. The space 121 may permit a human patron 114 to fit through between the prohibited object detector 122 and the barrier 120, thereby bypassing (e.g., walking around) the prohibited object detector 122, as indicated in FIG. 1 by arrows 119.

As shown in FIG. 3, the prohibited object detector 110 may be a multiple-unit (or multiple-structure) prohibited object detector 132 (e.g., a portable prohibited object detector system) having two vertical portions 124 (e.g., poles, posts, walls, members, etc.) each comprising a prohibited object detection device 126 (shown in phantom lines) operable to detect potentially prohibited objects carried by human patrons 114. The vertical portions 124 may not be connected together and, thus, may be independently movable (e.g., rotatable, linearly movable) with respect to each other. Accordingly, the vertical portions 124 may be positioned at a predetermined relative separation distance and/or angle on the floor 118 by human security offices 112 or other personnel before the prohibited object detector 132 is used to detect the potentially prohibited objects. The detection devices 126 may generate a prohibited object detection area 130 within which the prohibited object detector 132 can detect the potentially prohibited objects. However, when one or more of the vertical portions 124 of the prohibited object detector 132 are moved linearly (i.e., closer together or further apart), as indicated by arrows 127, and/or rotated, as indicated by arrows 129, the detection area 130 may contract (i.e., shrink) or otherwise loose its detection effectiveness, thereby permitting a human patron 114 to carry a potentially prohibited object through the prohibited object detector 132 without detection. Furthermore, when the vertical portions 124 are moved linearly 127 and/or rotated 129, a space (or gap) 121 may be formed or become larger with respect to the barrier 120, which may permit a human patron 114 to fit between the prohibited object detector 132 and the barrier 120 and thereby bypass (e.g., walk around) the prohibited object detector 132.

The security check environment 100 may further comprise or otherwise contain a security check monitoring system 200 operable to monitor security check operations that are being performed at the security check environment 100, determine if (or when) the security check operations (e.g., checking the human patrons 114 for prohibited objects) are being performed in a suboptimal (e.g., erroneous, unintended, improper, deceitful, etc.) manner, and output an alarm indicating that the security check operations are being performed in a suboptimal manner. In other words, the monitoring system 200 may be operable to detect and provide notice of erroneous, unintended, improper, deceitful, or otherwise suboptimal actions performed by a human patron 114 and/or human security officer 112 during and/or in preparation for security check operations. For example, the monitoring system 200 may be operable to detect that: a human patron 114 is using the prohibited object detector 110 in a suboptimal (e.g., erroneous, deceitful) manner; a human security officer 112 is operating or using the prohibited object detector 110 or other security equipment in a suboptimal (e.g., erroneous, unintended, etc.) manner; a human security officer 112 is manually performing security check operations on a human patron 114 in a suboptimal (e.g., erroneous, unintended, etc.) manner; and/or the human security officer 112 is configuring the prohibited object detector 110 in a suboptimal manner for use during security check operations.

The monitoring system 200 may comprise one or more sensors 202, 204, an alert output device 206, a processing device 208, and a control workstation 210. The sensors 202, 204, the output device 206, the processing device 208, and the control workstation 210 may be communicatively connected via wired and/or wireless communication means 212 (shown in phantom lines).

The sensors 202, 204 may be operable to output sensor data indicative of physical characteristics of one or more portions of the security check environment 100. Each of the sensors 202, 204 may comprise a field of view 205 that is directed toward a predetermined one or more portions of the security check environment 100, including the prohibited object detector 110, one or more of the human security officers 112, one or more of the human patrons 114, one or more of the carried objects 116, and/or the table 117 supporting the carried objects 116. The physical characteristics of the security check environment 100 that may be indicated by the sensor data output by the sensors 202, 204 may include, for example, distance (i.e., actual position or depth) of one or more portions of the security check environment 100, relative distance (or position) between one or more portions of the security check environment 100, a movement path (or direction) of one or more portions of the security check environment 100, size of one or more portions of the security check environment 100, and/or shape of one or more portions of the security check environment 100. The sensors 202, 204 may include one or more digital video cameras 202. The sensors 202, 204 may also or instead include one or more ranging devices 204 operable to determine distance (or location) of objects. The ranging devices 204 may be or comprise, for example, light detection and ranging devices (LIDARs) and/or sound (e.g., ultrasound, sonar, etc.) detection and ranging devices.

The alert output device 206 (e.g., display screen, a light, an audio speaker, etc.) may be operable to output a signal, such as an audio signal (e.g., an alarm) and/or a visual signal (e.g., a light, text, etc.), indicating to the human security officers 112 that the security check operations are being performed in a suboptimal manner. The output signal may describe or otherwise indicate to the human security officers 112 how the security check operations are being performed in a suboptimal manner. For example, the alert output device 206 may display text describing or otherwise indicating how the security check operations are being performed in a suboptimal manner.

The prohibited object detector 110 may also be communicatively connected to the monitoring system 200 via the communication means 212. The communicative connection may permit the processing device 208 and/or the control workstation to 210 to receive and monitor operational settings data and/or operational status data indicative of operational settings and operational status, respectively, of the prohibited object detector 110. The communicative connection may further permit the processing device 208 and/or the control workstation 210 to transmit control data to the prohibited object detector 110, such as to control operational settings and/or operational status of the prohibited object detector 110.

The processing device 208 (e.g., a controller, a programmable logic controller (PLC), a computer, etc.) may be operable to monitor operational performance of and provide control to one or more portions of the monitoring system 200 and/or the prohibited object detector 110. The processing device 208 may be operable to receive and process sensor data output by the sensors 202, 204 and output control data (i.e., control commands) to one or more portions of the monitoring system 200 and/or the prohibited object detector 110 to perform various operations described herein based on the sensor data. The processing device 208 may comprise a processor and a memory storing an executable computer program code, instructions, and/or operational parameters or set-points, including for implementing one or more aspects of methods and operations described herein. For example, execution of the computer program code by the processor may cause the processing device 208 to receive the sensor data output by the sensors 202, 204, determine if (or when) the security check operations are being performed in a suboptimal manner based on the sensor data, and, when the security check operations are being performed in a suboptimal manner, output alarm data to the output device 206 to cause the output device 206 to output an alarm signal indicative of the suboptimal manner in which the security check operations are being performed. When the security check operations are being performed in a suboptimal manner, the processing device 208 may output alarm data to the output device 206 to cause the output device 206 to output information (e.g., an audio message, a textual message, etc.) indicative of the optimal manner in which the security check operations are to be performed by the human security officers 112 and/or the human patrons 114. For example, the output device 206 may output information indicating how the human security officers 112 should check the human patrons 114 for prohibited objects. The output device 206 may also or instead output information indicating how the human patrons 114 should walk through the prohibited object detector 110. During or after the security check operations, the processing device 208 may also record the sensor data output by the sensors 202, 204 and/or data indicative of whether the security check operations are being performed in a suboptimal manner.

The control workstation 210 (i.e., a human-machine interface (HMI)) may be communicatively connected with the processing device 208, the sensors 202, 204, and/or the prohibited object detector 110 via the communication means 212, such as may permit the control workstation 210 to be used to control operational performance and/or settings of the processing device 208, the sensors 202, 204, and/or the prohibited object detector 110. The control workstation 210 may comprise one or more input devices (i.e., control devices) usable by a human security officer 112 to control the processing device 208, the sensors 202, 204, and/or the prohibited object detector 110. The input devices may comprise, for example, a joystick, a mouse, a keyboard, a touchscreen, and/or other input devices. The control workstation 210 may also comprise one or more output devices operable to visually and/or audibly show or otherwise indicate to the human security officer 112 status of the processing device 208, the sensors 202, 204, and/or the prohibited object detector 110. The output devices may comprise, for example, a gauge, a video monitor, a touchscreen, a light, an audio speaker, etc.).

The monitoring system 200 may further comprise a remote processing device 214 (e.g., a computer, a server, a database, etc.) communicatively connected with the sensors 202, 204, the processing device 208, and/or the control workstation 210. During or after the security check operations, the processing device 208 may transmit the sensor data output by the sensors 202, 204, the data indicative of whether the security check operations are being performed in a suboptimal manner, and/or other data output by the processing device 208 and/or the control workstation 210 to the remote processing device 214 for real-time analysis, recordation, and/or subsequent further analysis. The remote processing device 214 may be located outside of the security check environment 100, such as in a different room, a different building, or a different city. The remote processing device 214 may be accessible via a communication network 216, such as a local area network (LAN), a wide area network (WAN), a cellular network, or the internet.

During security check operations, the processing device 208 may generate a three-dimensional (or spatial) digital map (or image) of the security check environment 100 based on the sensor data output by one or more of the sensors 202, 204, and determine if the security check operations are being performed in a suboptimal manner based on the three-dimensional digital map. For example, the processing device 208 may generate a three-dimensional digital map of the security check environment 100 based on sensor data output by one or more of the sensors 202, 204 (e.g., at least one of the digital video cameras 202 and at least one of the ranging devices 204). The three-dimensional digital map may be indicative of, for example, distance (i.e., actual position or depth) of one or more portions of the security check environment 100, relative distance (or position) between one or more portions of the security check environment 100, movement path (e.g., direction) of one or more portions of the security check environment 100, size of one or more portions of the security check environment 100, and/or shape of one or more portions of the security check environment 100.

The three-dimensional digital map of the security check environment 100 may comprise digital models of various portions of the security check environment 100, which may include the prohibited object detector 110, the security table 117, one or more human security officers 112, one or more human patrons 114, and one or more carried objects 116 carried by the human patrons 114. The processing device 208 may analyze the digital models of the security check environment 100 to recognize and determine physical characteristics of predetermined portions of the security check environment 100, such as, for example, distance (i.e., actual position or depth) of one or more portions of the security check environment 100, relative distance (or position) between one or more portions of the security check environment 100, movement path (e.g., direction) of one or more portions of the security check environment 100, size of one or more portions of the security check environment 100, and/or shape of one or more portions of the security check environment 100.

In an example implementation of the monitoring system 200, the ranging devices 204 may output sensor data comprising digital position points (or dots) indicative of depth (or distance) of various portions of the security check environment 100. The processing device 208 may track position (or location) and movement of the digital position points. The processing device 208 may recognize the digital position points associated with predetermined portions of the security check environment 100. By tracking the digital position points, the processing device 208 can stich the sensor data output by the video cameras 202 and the sensor data output by the ranging devices 204 to facilitate tracking of position and movement of the predetermined portions of the security check environment 100 with high accuracy (e.g., 99% when the sensors 202, 204 are within 6.1 meters (20 feet) of the predetermined portions of the security check environment 100).

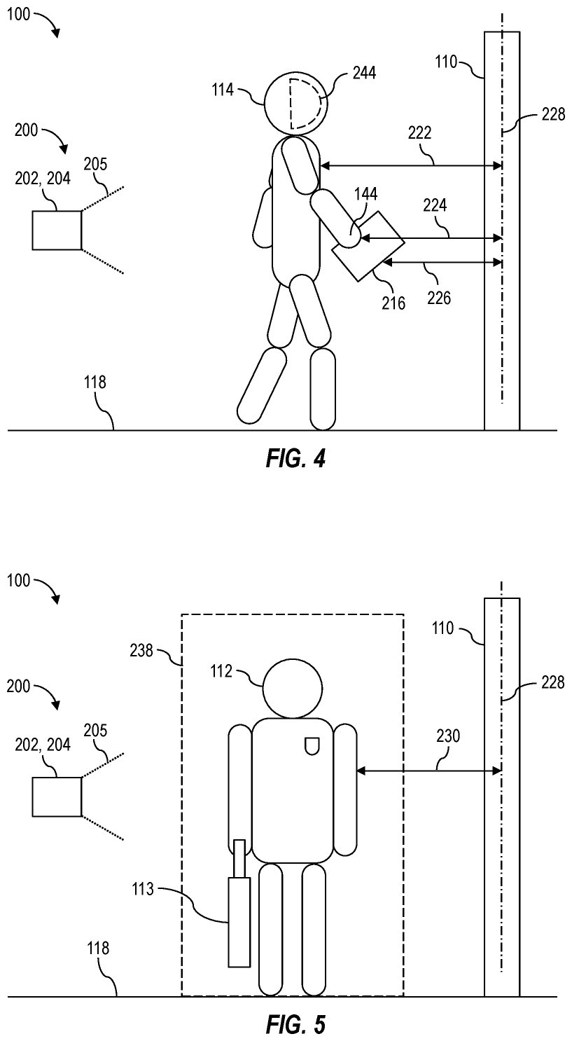

FIGS. 2-4 are schematic views of a portion of the security check environment 100 shown in FIG. 1 during security check operations when the monitoring system 200 is being used to determine if (or when) the security check operations are being performed in a suboptimal manner. Accordingly, the following description refers to FIGS. 1-4, collectively.

During security check operations, the processing device 208 may determine (or measure) a position 222 of a human patron 114, a position 224 of a portion (e.g., a hand 144) of a human patron 114, and/or a position 226 of an object 116 carried by the human patron 114 based on sensor data associated with the human patron 114 (e.g., the digital model of the human patron 114). Such positions 222, 224, 226 may be determined relative to (with respect to) a position 228 of the prohibited object detector 110 based on sensor data associated with the human patron 114 and the prohibited object detector 110 (e.g., the digital model of the human patron 114 and the digital model of the prohibited object detector 110).

The processing device 208 may be further operable to determine a movement path 222 (e.g., direction) of a human patron 114, a movement path 224 of a portion (e.g., a hand 144) of a human patron 114, and/or a movement path 226 of an object 116 carried by a human patron 114 based on sensor data associated with the human patron 114 (e.g., the digital model of the human patron 114). Such movement paths 222, 224, 226 may be determined relative to (with respect to) the position 228 of the prohibited object detector 110 based on sensor data associated with the human patron 114 and the prohibited object detector 110 (e.g., the digital model of the human patron 114 and the digital model of the prohibited object detector 110).

For example, the processing device 208 may be operable to recognize the prohibited object detector 110 in the three-dimensional digital map, recognize a human patron 114 in the three-dimensional digital map, and determine one or more of the positions 222, 224, 226 and/or movement paths 222, 224, 226 with respect to the position 228 of the prohibited object detector 110 based on the three-dimensional digital map. The processing device 208 may be further operable to then determine if the security check operations are being performed in a suboptimal manner based on the determined positions 222, 224, 226 and/or movement paths 222, 224, 226 with respect to the prohibited object detector 110.

Accordingly, the processing device 208 may determine that the security check operations are being performed in a suboptimal manner based on suboptimal (e.g., erroneous, unintended, improper, deceitful, etc.) actions by a human patron 114, such as, for example, when: the human patron 114 walks around 119 and not through the prohibited object detector 110; the human patron 114 walks through 115 the prohibited object detector 110 while carrying an object 116 through the prohibited object detector 110 (as shown in FIGS. 2-4); the human patron 114 walks through 115 the prohibited object detector 110 while positioning at least one hand 144 outside of (e.g., above) the prohibited object detector 110 (as shown in FIGS. 2 and 3); the human patron 114 walks through 115 the prohibited object detector 110 while carrying the object 116 outside of the prohibited object detector 110 (as shown in FIGS. 2 and 3); the human patron 114 walks through 115 the prohibited object detector 110 while positioning at least one hand 144 outside of (e.g., above) the prohibited object detection area 130 of the prohibited object detector 110 (as shown in FIGS. 2 and 3); the human patron 114 walks through 115 the prohibited object detector 110 while carrying the object 116 outside of the prohibited object detection area 130 of the prohibited object detector 110 (as shown in FIGS. 2 and 3); after the human patron 114 walks through 115 the prohibited object detector 110 and the prohibited object detector 110 detects the potentially prohibited object, the human patron 114 fails to walk back 117 through the prohibited object detector 110; and/or after the human patron 114 walks through 115 the prohibited object detector 110 and the prohibited object detector 110 detects the potentially prohibited object, the human patron 114 fails to present the potentially prohibited object to the human security officer 112.

During security check operations, the processing device 208 may analyze the sensor data associated with human patrons 114 (e.g., the digital model of the human patron 114) to detect (i.e., perform facial recognition operations) facial features 244 (shown in phantom lines) of the human patrons 114. The processing device 208 may be further operable to compare the facial features 244 of the human patrons 114 to facial features of human criminals (e.g., terrorists) stored on the processing device 208, the remote processing device 214, or a third party (e.g., a federal government) remote processing device (not shown). When the facial features 244 of a human patron 114 match facial features of a human criminal, the processing device 208 may output alarm data to the output device 206 to cause the output device 206 to output an alarm signal indicative of such match.

FIGS. 5-7 are schematic views of a portion of the security check environment 100 shown in FIGS. 1-4 during security check operations when the monitoring system 200 is being used to determine if the security check operations are being performed in a suboptimal manner. Accordingly, the following description refers to FIGS. 1-7, collectively.

As shown in FIG. 5, during security check operations, the processing device 208 may determine a position (or distance) 230 and/or a movement path (or direction) 230 of a human security officer 112 relative to the prohibited object detector 110 based on sensor data associated with the human security officer 112 and the position 228 of the prohibited object detector 110 (e.g., the digital model of the human security officer 112 and the prohibited object detector 110).

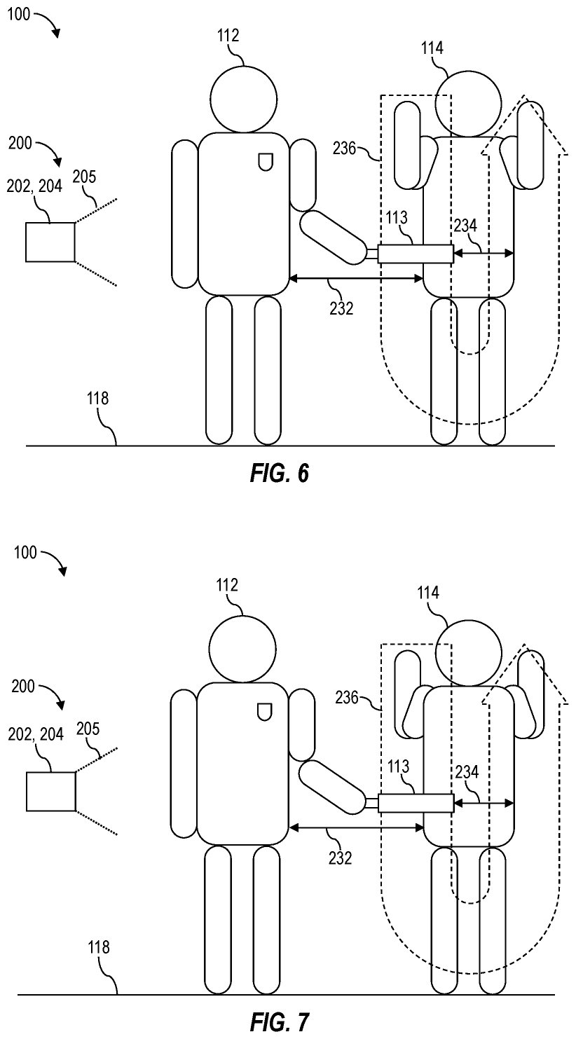

As shown in FIGS. 6 and 7, during security check operations, the processing device 208 may determine a position (or distance) 232 of a human security officer 112 or a position 234 of a portion (e.g., an arm, a handheld metal detector 113, etc.) of the human security officer 112 relative to (with respect to) a human patron 114 based on sensor data associated with the human security officer 112 and the human patron 114 (e.g., the digital model of the human security officer 112 and the digital model of the human patron 114). The processing device 208 may be further operable to determine a path (e.g., a direction) 232 of movement of a human security officer 112 or a path 236 of movement of a portion (e.g., an arm, a handheld metal detector 113, etc.) of the human security officer 112 relative to (with respect to) a human patron 114 based on sensor data associated with the human security officer 112 and the human patron 114 (e.g., the digital model of the human security officer 112 and the digital model of the human patron 114). The processing device 208 may then determine if the security check operations are being performed in a suboptimal manner based on the determined relative positions 232, 234 and/or movement paths 232, 236. Accordingly, the processing device 208 may determine that the security check operations are being performed in a suboptimal manner based on suboptimal (e.g., erroneous, unintended, improper, etc.) actions by a human security officer 112, such as, for example, when the human security officer 112 fails to check the human patron 114 for a potentially prohibited object using a predetermined check procedure.

An example predetermined check procedure to check a human patron 114 for a potentially prohibited object may include checking the human patron 114 for a potentially prohibited object using a handheld metal detector (or wand) 113 in a correct or otherwise predetermined manner, such as when the prohibited object detector 110 detects a potentially prohibited object on the human patron 114. Such predetermined manner of using the handheld metal detector 113 may include moving the handheld metal detector along a U-shaped path (or motion) 236 along the body of the human patron 114. The predetermined manner of using the handheld metal detector 113 may be the “U-Shaped Screening Technique” defined in the Department of Homeland Security guide, which includes security steps such as: instructing the patron (e.g., the human patron 114) to remove all metal items from his or her pockets and hold the items (e.g., carried objects 116) at shoulder height with elbows at his or her sides; inspecting the items in the patron's hands; instructing the patron to stand with their feet shoulder width apart; screening the patron with the handheld metal detector starting in front of the patron at the top right shoulder area; moving the handheld metal detector down the front of the patron to the right foot; moving to the left foot; bringing the handheld metal detector up to the top left shoulder area in a U-shaped motion; instructing the patron to turn around; repeating the U-shaped motion; if an alarm sounds, stop screening and proceed with a limited pat-down of the area in question; and then rescreen the area again to make sure it is clear.

The processing device 208 may determine that the security check operations are being performed in a suboptimal manner also based on lack of predetermined actions (or nonactions) by a human security officer 112, such as, for example, when: the human security officer 112 fails to check a human patron 114 for a potentially prohibited object; and/or the human security officer 112 fails to check contents of (e.g., open) an object 116 (e.g., a handbag) carried by the human patron 114 for potentially prohibited objects.

As shown in FIG. 5, the processing device 208 may determine that the security check operations are being performed in a suboptimal manner also based on lack of other predetermined actions by a human security officer 112, such as when the human security officer 112 fails to maintain a predetermined post (e.g., station, position, distance, etc.) at the security check environment 100. The human security officer 112 fails to maintain a predetermined post at the security check environment 100, for example, when: the human security officer 112 is not stationed at his/her station 238 (e.g., behind the table 117, next to the prohibited object detector 110, etc.) for more than a predetermined period of time; the human security officer 112 is not within a predetermined distance 230 of or otherwise with respect to the prohibited object detector 110 for more than a predetermined period of time; and/or the human security officer 112 is busy dealing with a security incident for more than a predetermined period of time.

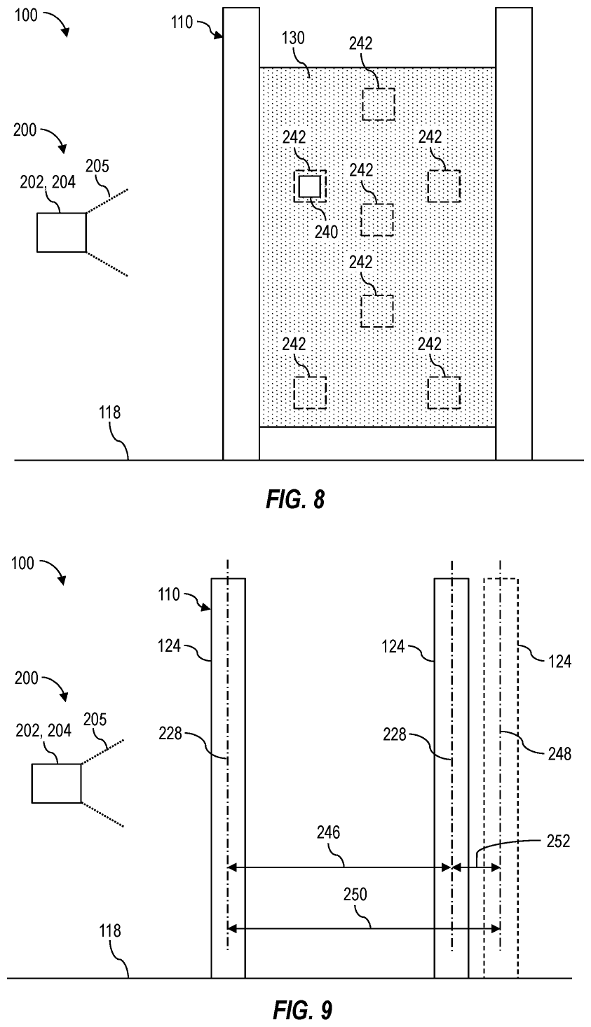

As shown in FIG. 8, the processing device 208 may determine that the security check operations are being performed in a suboptimal manner also based on lack of still other predetermined actions (or nonactions) by a human security officer 112, such as, for example, when: the human security officer 112 fails to test operation of the prohibited object detector 110 at a predetermined time (e.g., every four hours, every morning, once a week, etc.); and/or the human security officer 112 fails to test operation of the prohibited object detector 110 using a predetermined test procedure. An example predetermined test procedure for testing operation of the prohibited object detector 110 may include testing detection functionality of the prohibited object detector 110 by moving a test prohibited object 240 along a plurality of test paths 242 (each shown in phantom lines) through the detection area 130 of the prohibited object detector 110. The test paths 242 may include three test paths (each at a different height) on the left side of the detection area 130, three test paths (each at a different height) on the right side of the detection area 130, and three test paths (each at a different height) through the middle of the detection area 130. To test the functionality of the prohibited object detector 110, the processing device 208 may indicate to human security officer 112 or other personnel, via the control workstation 210 and/or the output device 206, to move the test prohibited object 240 along the predetermined plurality of test paths 242 through the detection area 130 of the prohibited object detector 110 while the processing device 208 receives and analyzes the sensor data output by one or more of the sensors 202, 204. The processing device 208 may then determine if the test prohibited object 240 is carried by a human (e.g., a human security officer 112) along each of the predetermined plurality of test paths 242 through the detection area 130 of the prohibited object detector 110. The processing device 208 may then receive from the prohibited object detector 110, via the communication means 212, detection data indicative of whether the prohibited object detector 110 detected the test prohibited object 240 during each movement (or pass) through the detection area 130. The processing device 208 may also or instead receive the detection data that is input manually into the processing device 208 via the control workstation 210 by a human security officer 112. The human security officer 112 performing the test procedure may also enter into the processing device 208 contextual data indicative of, for example: identity of the human security officer 112 performing the test; date of the test procedure; time of the test procedure; whether the prohibited object detector 110 successfully detected the test prohibited object 240 during each movement through the detection area 130; whether the prohibited object detector 110 did not successfully detect the test prohibited object 240 during each movement through the detection area 130; and/or how the human security officer 112 changed the operational settings of the prohibited object detector 110 such that the prohibited object detector 110 eventually successfully detected the test prohibited object 240 during each movement through the detection area 130. The processing device 208 may record the detection data and the contextual data entered during the testing operations, and/or the processing device 208 may transmit such data to the remote processing device 214 for real-time analysis, recordation, and subsequent further analysis.

FIG. 9 is still another schematic view of a portion of the security check environment 100 shown in FIGS. 1-8 during security check operations when the monitoring system 200 is being used to determine if the security check operations are being performed in a suboptimal manner. Accordingly, the following description refers to FIGS. 1-9, collectively.

As shown in FIG. 9, during security check operations, the processing device 208 may determine (or measure) a position (i.e., an actual position) of the prohibited object detector 110 based on sensor data associated with the prohibited object detector 110 (e.g., the digital model of the prohibited object detector 110) output by the sensors 202, 204. The actual position of the prohibited object detector 110 may comprise: an actual position 228 (e.g., a linear position or an angular position) of the whole prohibited object detector 110; an actual position 228 (e.g., a linear position or an angular position) of a predetermined portion 124 (e.g., pole, post, wall, member, etc.) of the prohibited object detector 110; and/or an actual distance 246 (e.g., a linear distance or an angular distance) between predetermined portions 124 (e.g., poles, posts, walls, members, etc.) of the prohibited object detector 110 (e.g., a metal detector). The processing device 208 may then determine a position difference 252 (e.g., a linear position difference or an angular position difference) between the actual position of the prohibited object detector 110 and an intended position of the prohibited object detector 110. The intended position of the prohibited object detector 110 may comprise an intended position 248 (e.g., an intended linear position or an intended angular position) of the whole prohibited object detector 110; an intended position 248 (e.g., an intended linear position or an intended angular position) of a predetermined portion 124 (e.g., pole, post, wall, member, etc.) of the prohibited object detector 110; and/or an intended distance 250 (e.g., an intended linear distance or an intended angular distance) between predetermined portions 124 (e.g., poles, posts, walls, members, etc.) of the prohibited object detector 110 (e.g., a metal detector). The processing device 208 may then determine that the prohibited object detector 110 is used in a suboptimal manner to detect the potentially prohibited object when the position difference 252 is greater than a predetermined threshold. When the position difference 252 is greater than the predetermined threshold, the processing device 208 may then output alarm data to the output device 206 to cause the output device 206 to output an alarm signal indicative of: the actual position of the prohibited object detector 110; and/or the position difference 252 between the actual position of the prohibited object detector 110 and an intended position 248 of the prohibited object detector 110. The alarm data may also or instead cause the output device 206 to output an alarm signal indicative of mere existence of the position difference 252, such as a light or text indicating that one or more portions 124 are not located at intended positions 248 or are otherwise not positioned as intended. The alarm signal may also or instead instruct the human security officers 112 to check the physical setup (or relative distances) of the predetermined portions 124 of the prohibited object detector 110.

During security check operations, the processing device 208 may, thus, determine (or measure) the distance 246 between predetermined portions 124 (e.g., poles, posts, walls, members, etc.) of the prohibited object detector 110 based on the sensor data (e.g., a digital model of the prohibited object detector 110). The processing device 208 may then determine that the security check operations are being performed in a suboptimal manner to detect the potentially prohibited object when the determined distance 246 is greater than a maximum predetermined distance between the predetermined portions 124 of the prohibited object detector 110 or less than a minimum predetermined distance between the predetermined portions of the prohibited object detector 110.

During or after the security check operations, the processing device 208 may transmit the sensor data output by the sensors 202, 204, the data indicative of whether the security check operations are being performed in a suboptimal manner, and/or other data output by the processing device 208 to other devices. For example, the processing device 208 may transmit such data to the output device 206 and/or the control workstation 210 to alert or otherwise notify the human security officers 112 in real-time that the security check operations are being performed in a suboptimal manner. The processing device 208 may also or instead transmit such data to the remote processing device 214 to alert or otherwise notify other human security personnel in real-time that the security check operations are being performed in a suboptimal manner, to record the data, and/or for subsequent analysis. The processing device 208 may also or instead transmit such data to a mobile device (e.g., a laptop, a cellular phone, etc.) to alert or otherwise notify the human security officers 112 and/or other human security personnel in real-time that the security check operations are being performed in a suboptimal manner, to record the data, and/or for subsequent analysis. The output device 206, the control workstation 210, the remote processing device 214, and/or the mobile device may output an audio and/or visual alarm indicating to the human security officers 112 and/or other human security personnel in real-time: that the security check operations are being performed in a suboptimal manner; how the security check operations are being performed in a suboptimal manner; and/or the corrective course of action that the human security officers 112 and/or other human security personnel can take such that the security check operations will be performed in an optimal manner.

The monitoring system 200 may be further operable to control operation of the prohibited object detector 110 based on the determination that the prohibited object detector 110 is being operated in a suboptimal manner. For example, the processing device 208 of the monitoring system 200 may be operable to control operation of a prohibited object detector 110 based on the determination that the prohibited object detector 110 is being used to detect a potentially prohibited object in a suboptimal manner during security check operations. The processing device 208 of the monitoring system 200 may also or instead be operable to control (e.g., adjust or configure) operation of the prohibited object detector 110 based on the determination that the prohibited object detector 110 is being tested (or configured) in a suboptimal manner during testing operations. Thus, if (or when) the processing device 208 of the monitoring system 200 determines, based on the sensor data, that the security check operations and/or the testing operations at the security check environment 100 are being performed in a suboptimal manner, the processing device 208 may output control data to the prohibited object detector 110 to control operation of the prohibited object detector 110. Control data output by the processing device 208 may be indicative of operational setting of the prohibited object detector 110. Operational setting of the prohibited object detector 110 may include, for example, adjustments to: sensitivity to detect potentially prohibited objects by the prohibited object detection device 126 of the prohibited object detector 110; geometric dimensions (e.g., shape, size, height, etc.) of the detection field defining the prohibited object detection area (or space) 130; and/or characteristics (e.g., frequency, wavelength, intensity, etc.) of the detection field.

For example, the processing device 208 may output control data to the prohibited object detector 110 to control operation of the prohibited object detector 110 if (or when) the processing device 208 detects or otherwise determines that: a human patron 114 carries an object 116 through the prohibited object detector 110 and the prohibited object detector 110 does not detect a potentially prohibited object and, thus, does not output an audio/visual alarm; the human patron 114 walks through the prohibited object detector 110 while positioning at least one hand 144 outside of the prohibited object detector 110; the human patron 114 walks through the prohibited object detector 110 while carrying an object 116 outside of the prohibited object detector 110; the human patron 114 walks through the prohibited object detector 110 while positioning at least one hand 144 outside of the detection area 130 of the prohibited object detector 110; the human patron 114 walks through the prohibited object detector 110 while carrying an object 116 outside of the detection area 130; a human security officer 112 fails to check the human patron 114 for prohibited objects using a predetermined check procedure; the human security officer 112 fails to test operation of the prohibited object detector 110 at a predetermined time; the human security officer 112 fails to test operation of the prohibited object detector 110 using a predetermined test procedure; and/or the human security officer 112 carries a test prohibited object 240 through the prohibited object detector 110 and the prohibited object detector 110 does not detect the test prohibited object.

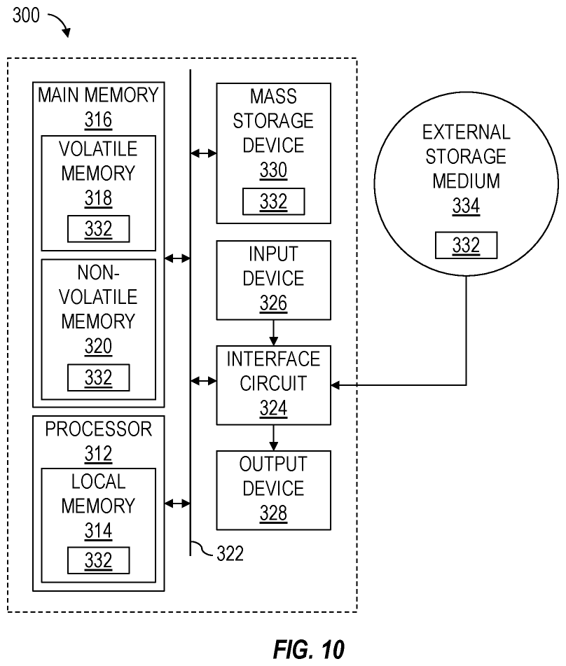

FIG. 10 is a schematic view of at least a portion of an example implementation of a processing device 300 (or system) according to one or more aspects of the present disclosure. The processing device 300 may be or form at least a portion of one or more electronic devices shown in one or more of FIGS. 1-9. Accordingly, the following description refers to FIGS. 1-10, collectively.

The processing device 300 may be or comprise, for example, one or more processors, controllers, special-purpose computing devices, PCs (e.g., desktop, laptop, and/or tablet computers), personal digital assistants, smartphones, IPCs, PLCs, servers, internet appliances, and/or other types of computing devices. The processing device 300 may be or form at least a portion of the processing devices 208, 214 and the control workstation 210 of the monitoring system 200. The processing device 300 may also be or form at least a portion of the prohibited object detector 110 of the security check environment 100. Although it is possible that the entirety of the processing device 300 is implemented within one device, it is also contemplated that one or more components or functions of the processing device 300 may be implemented across multiple devices, some or an entirety of which may be at the security check environment 100 and/or remote from the security check environment 100.

The processing device 300 may comprise a processor 312, such as a general-purpose programmable processor. The processor 312 may comprise a local memory 314, and may execute machine-readable and executable program code instructions 332 (i.e., computer program code) present in the local memory 314 and/or other memory devices. The processor 312 may execute, among other things, the program code instructions 332 and/or other instructions and/or programs to implement the example methods and/or operations described herein. For example, the program code instructions 332, when executed by the processor 312 of the processing device 300, may cause the processor 312 to receive and process: sensor data (e.g., sensor measurements) output by the sensors 202, 204; and/or operational settings and/or operational status data output by the prohibited object detector 110. The program code instructions 332, when executed by the processor 312 of the processing device 300, may also or instead output control data (or control commands) to cause one or more portions of the monitoring system 200 (e.g., the sensors 202, 204, the output device 206, etc.) and/or the security check environment 100 (e.g., the prohibited object detector 110) to perform the example methods and/or operations described herein. The processor 312 may be, comprise, or be implemented by one or more processors of various types suitable to the local application environment, and may include one or more of general-purpose computers, special-purpose computers, microprocessors, digital signal processors (DSPs), field-programmable gate arrays (FPGAs), application-specific integrated circuits (ASICs), and processors based on a multi-core processor architecture, as non-limiting examples. Examples of the processor 312 include one or more INTEL microprocessors, microcontrollers from the ARM, PIC, and/or PICO families of microcontrollers, embedded soft/hard processors in one or more FPGAs.

The processor 312 may be in communication with a main memory 316, such as may include a volatile memory 318 and a non-volatile memory 320, perhaps via a bus 322 and/or other communication means. The volatile memory 318 may be, comprise, or be implemented by random access memory (RAM), static random-access memory (SRAM), synchronous dynamic random-access memory (SDRAM), dynamic random-access memory (DRAM), RAMBUS dynamic random-access memory (RDRAM), and/or other types of random-access memory devices. The non-volatile memory 320 may be, comprise, or be implemented by read-only memory, flash memory, and/or other types of memory devices. One or more memory controllers (not shown) may control access to the volatile memory 318 and/or non-volatile memory 320.

The processing device 300 may also comprise an interface circuit 324, which is in communication with the processor 312, such as via the bus 322. The interface circuit 324 may be, comprise, or be implemented by various types of standard interfaces, such as an Ethernet interface, a universal serial bus (USB), a third-generation input/output (3GIO) interface, a wireless interface, a cellular interface, and/or a satellite interface, among others. The interface circuit 324 may comprise a graphics driver card. The interface circuit 324 may comprise a communication device, such as a modem or network interface card to facilitate exchange of data with external computing devices via a network (e.g., Ethernet connection, digital subscriber line (DSL), telephone line, coaxial cable, cellular telephone system, satellite, etc.).

The processing device 300 may be in communication with various sensors, video cameras, actuators, processing devices, equipment controllers, and other devices of the monitoring system 200 and/or the security check environment 100 via the interface circuit 324. The interface circuit 324 can facilitate communications between the processing device 300 and one or more devices by utilizing one or more communication protocols, such as an Ethernet-based network protocol (such as ProfiNET, OPC, OPC/UA, Modbus TCP/IP, EtherCAT, UDP multicast, Siemens S7 communication, or the like), a proprietary communication protocol, and/or another communication protocol.

One or more input devices 326 may also be connected to the interface circuit 324. The input devices 326 may permit human users (e.g., human security officers 112) to enter the program code instructions 332, which may be or comprise control commands, operational parameters, physical properties, and/or operational set-points. The program code instructions 332 may further comprise modeling or predictive routines, equations, algorithms, processes, applications, and/or other programs operable to perform example methods and/or operations described herein. The input devices 326 may be, comprise, or be implemented by a keyboard, a mouse, a joystick, a touchscreen, a trackpad, a trackball, an isopoint, and/or a voice recognition system, among other examples. One or more output devices 328 may also be connected to the interface circuit 324. The output devices 328 may permit visualization or other sensory perception of various data, such as sensor data, status data, contextual data, and/or other example data. The output devices 328 may be, comprise, or be implemented by video output devices (e.g., an LCD, an LED display, a CRT display, a touchscreen, etc.), printers, and/or speakers, among other examples. The one or more input devices 326 and the one or more output devices 328 connected to the interface circuit 324 may, at least in part, facilitate the HMI devices described herein.

The processing device 300 may comprise a mass storage device 330 for storing data and program code instructions 332. The mass storage device 330 may be connected to the processor 312, such as via the bus 322. The mass storage device 330 may be or comprise a tangible, non-transitory storage medium, such as a floppy disk drive, a hard disk drive, a compact disk (CD) drive, and/or digital versatile disk (DVD) drive, among other examples. The processing device 300 may be communicatively connected with an external storage medium 334 via the interface circuit 324. The external storage medium 334 may be or comprise a removable storage medium (e.g., a CD or DVD), such as may be operable to store data and program code instructions 332.

As described above, the program code instructions 332 may be stored in the mass storage device 330, the main memory 316, the local memory 314, and/or the removable storage medium 334. Thus, the processing device 300 may be implemented in accordance with hardware (perhaps implemented in one or more chips including an integrated circuit, such as an ASIC), or may be implemented as software or firmware for execution by the processor 312. In the case of firmware or software, the implementation may be provided as a computer program product including a non-transitory, computer-readable medium or storage structure embodying computer program code instructions 332 (i.e., software or firmware) thereon for execution by the processor 312. The program code instructions 332 may include program instructions or computer program code that, when executed by the processor 312, may perform and/or cause performance of example methods, processes, and/or operations described herein.

For example, the program code instructions 332 stored on one or more of the memories 318, 320, 314, 330, 334 of the processing device 300 may comprise object recognition (i.e., vision) software, which when executed by the processor 312 of the processing device 300 may cause the processing device 300 to receive and analyze (i.e., process) the sensor data generated by the sensors 202, 204 to recognize predetermined portions of the security check environment 100. In an example implementation, the object recognition software, which when executed by the processor 312 of the processing device 300 may cause the processing device 300 to generate a three-dimensional digital map of the security check environment 100 comprising digital models of the recognized predetermined portions of the security check environment 100. The processing device 300 may then determine physical characteristics of the recognized predetermined portions of the security check environment 100, as described herein.

The program code instructions 332 stored on one or more of the memories 318, 320, 314, 330, 334 of the processing device 300 may also or instead utilize or comprise aspects of artificial intelligence (AI) (including machine learning) to analyze the sensor data generated by the sensors 202, 204 to recognize predetermined portions (e.g., the prohibited object detector 110, the human security officers 112, the human patrons 114, etc.) of the security check environment 100 and then determine physical characteristics (e.g., positions and/or movements) of the recognized predetermined portions of the security check environment 100, as described herein. The processing device 300 may be operable to generate (i.e., train or teach) an AI model of the security check environment 100 by processing or otherwise based on labeled sensor data indicative of or otherwise associated with: positions and/or movements of various equipment of the security check environment 100, positions and/or movements of the human security officers 112; and/or positions and/or movements of the human patrons 114.

Labeled sensor data may comprise sensor data (e.g., three-dimensional digital maps, digital models, digital images, digital movies, scans, etc.) described herein and label (i.e., identifying) data (e.g., digital position points, pixels, etc.) indicative of or otherwise associated with predetermined portions of the security check environment 100, such as the prohibited object detector 110, the security table 117, and the barriers 120. Labeled sensor data may thus comprise sensor data (e.g., three-dimensional digital maps, digital models, digital images, digital movies, scans, etc.) described herein and label (i.e., identifying) data (e.g., digital position points, pixels, etc.) indicative of or otherwise associated with predetermined portions of the security check environment 100, such as the prohibited object detector 110, the security table 117, the barriers 120, the human security officers 112, the human patrons 114, and/or the objects 116 carried by the human patrons 114. Label data may thus associate the sensor data with corresponding (or real-world) predetermined portions of the security check environment 100.

Labeled sensor data may comprise, be indicative of, or otherwise be based on intended, proper, or otherwise optimal configurations (e.g., positions) of the security check environment 100, such as when the prohibited object detector 110 and the barriers 120 are positioned or arranged in an intended, proper, or be otherwise optimal manner such that the security check operations can be performed in an optimal manner. An AI model may thus comprise, be indicative of, or otherwise be based on intended, proper, or otherwise optimal configurations of the security check environment 100. For example, the AI model may be based on images or movies of the prohibited object detector 110 when the prohibited object detector 110 and the barriers 120 are positioned in an intended, proper, or otherwise optimal manner.

Labeled sensor data may be indicative of or otherwise based on intended, proper, or otherwise optimal configurations (e.g., positions, movements, etc.) of the security check environment 100, such as when the human patrons 114 move in an intended, proper, or otherwise optimal manner such that the human security officer 112 and/or the prohibited object detector 110 can perform the security check operations of the human patrons 114 in an optimal manner. An AI model may thus also be indicative of or otherwise based on intended, proper, or otherwise optimal positions and/or movements of the human patrons 114. An AI model may thus be indicative of or otherwise based on intended, proper, or otherwise optimal positions and/or movements of the human patrons 114. For example, the AI model may be based on images or movies of the human patrons 114 being positioned in and/or moving through the prohibited object detector 110 in an intended, proper, or otherwise optimal manner.

Labeled sensor data may be indicative of or otherwise based on intended, proper, or otherwise optimal configurations (e.g., positions, movements, etc.) of the security check environment 100, such as when the human security officers 112 are positioned (i.e., stationed) or move in an intended, proper, or otherwise optimal manner such that the human security officer 112 can perform the security check operations in an optimal manner. An AI model may thus be indicative of or otherwise based on intended, proper, or otherwise optimal positions and/or movements of the human security officers 112. For example, the AI model may be based on images or movies of: the human security officers 112 being positioned in intended, proper, or otherwise optimal locations with respect to other portions of the security check environment 100; and/or the human security officers 112 performing the security check operations (e.g., moving the handheld metal detector along a U-shaped path 236 along the body of the human patron 114) in intended, proper, or otherwise optimal manner.

After the AI model is generated, the processing device 300 may store the AI model on one or more of the memories 318, 320, 314, 330, 334 of the processing device 300. Thereafter, during security check operations, the processing device 300 may execute the AI model and analyze new sensor data indicative of physical characteristics of various portions of the security check environment 100 output by the sensors 202, 204 using the AI model. The AI model may analyze the new sensor data to find data patterns in the new sensor data that are similar to know (i.e., trained or taught) data patterns of the AI model indicative of known portions of the security check environment 100 in order to recognize (or associate) the predetermined portions (e.g., the prohibited object detector 110, the human security officers 112, the human patrons 114, the objects 116, etc.) of the security check environment 100 (i.e., to predict which data points are associated with which predetermined portion of the security check environment 100) defined by the new sensor data. The processing device 300 may then associate physical characteristics indicated by the new sensor data with corresponding (or recognized) predetermined portions of the security check environment 100.

The AI model may analyze the new sensor data associated with predetermined portions (e.g., the prohibited object detector 110, the human security officers 112, the human patrons 114, etc.) of the security check environment 100 to determine (i.e., measure) positions and/or movements of the predetermined portions of the security check environment 100 and compare them to the intended, proper, or otherwise optimal positions and/or movements of the predetermined portions of the security check environment 100. Thereafter, the processing device 300 may determine whether the security check operations are being performed in a suboptimal manner based on differences between the determined positions and/or movements of the predetermined portions of the security check environment 100 and the optimal positions and/or movements of the predetermined portions of the security check environment 100.

The present disclosure is further directed to example methods (e.g., operations, processes, actions) for operating or commencing operation of the monitoring system 200 and/or the security check environment 100, as described herein according to one or more aspects of the present disclosure. The example methods may be performed utilizing or otherwise in conjunction with at least a portion of one or more implementations of one or more instances of the apparatus shown in one or more of FIGS. 1-10, and/or otherwise within the scope of the present disclosure. For example, the methods may be performed and/or caused, at least partially, by a processing device, such as the processing device 300 executing program code instructions 332 according to one or more aspects of the present disclosure. Thus, the present disclosure is also directed to a non-transitory, computer-readable medium comprising the program code instructions 332 that, when executed by the processing device 300, may cause the processing device 300, the monitoring system 200, and/or the security check environment 100 to perform the example methods described herein. The methods may also or instead be performed and/or caused, at least partially, by human personnel (e.g., the human security officers 112) utilizing one or more instances of the apparatus shown in one or more of FIGS. 1-10, and/or otherwise within the scope of the present disclosure. However, the methods may also be performed in conjunction with implementations of apparatus other than those depicted in FIGS. 1-10 that are also within the scope of the present disclosure.

In view of the entirety of the present disclosure, a person having ordinary skill in the art will readily recognize that the present disclosure introduces a system comprising: a sensor operable to output sensor data indicative of physical characteristics of a security check environment; an output device; and a processing device comprising a processor and a memory storing a computer program code which when executed by the processor causes the processing device to: determine, based on the sensor data, that security check operations at the security check environment are being performed in a suboptimal manner; and in response to determining that the security check operations are being performed in a suboptimal manner, output alarm data to the output device to cause the output device to output an alarm signal indicative of the suboptimal manner in which the security check operations are being performed.

The security check environment may comprise at least one of: a prohibited object detector operable to detect a potentially prohibited object; a human patron who intends to walk through the prohibited object detector; an object carried by the human patron; and a human security officer. The prohibited object detector may comprise at least one of: a metal detector; an X-ray machine; a millimeter wave scanner; a trace portal machine; a frequency machine; a radio wave signal machine; and a weapons detection system. The sensor may comprise a ranging device. The sensor may also or instead comprise a digital video camera.

The sensor may be a first sensor, the sensor data may be a first sensor data, and the first sensor may comprise a digital video camera. The system may further comprise a second sensor comprising a ranging device operable to output second sensor data indicative of the physical characteristics of the security check environment, and determining that the security check operations are being performed in a suboptimal manner may be further based on the second sensor data.

The sensor may be a first sensor, the sensor data may be a first sensor data, and the first sensor may comprise a digital video camera. The system may further comprise a second sensor comprising a ranging device operable to output second sensor data indicative of the physical characteristics of the security check environment, the computer program code executed by the processor may further cause the processing device to generate a three-dimensional digital map of the security check environment based on the first and second sensor data, and determining that the security check operations are being performed in a suboptimal manner may be further based on the three-dimensional digital map.

The computer program code executed by the processor further may cause the processing device to: generate a first digital model of the prohibited object detector based on the sensor data; generate a second digital model of the human patron based on the sensor data; and determine a position of the human patron with respect to the prohibited object detector based on the first and second digital models. Determining that the security check operations are being performed in a suboptimal manner may be based on the determined position of the human patron with respect to the prohibited object detector.

The suboptimal performance of the security check operations may comprise at least one of: the human patron walking around and not through the prohibited object detector; the human patron carrying an object through the prohibited object detector; the human patron walking through the prohibited object detector while positioning at least one hand outside of the prohibited object detector; the human patron walking through the prohibited object detector while carrying an object outside of the prohibited object detector; the human patron walking through the prohibited object detector while positioning at least one hand outside of a prohibited object detection area of the prohibited object detector; the human patron walking through the prohibited object detector while carrying an object outside of the prohibited object detection area; the human patron failing to walk back through the prohibited object detector after the human patron walked through the prohibited object detector and the prohibited object detector detected a potentially prohibited object; the human patron failing to present to the human security officer a potentially prohibited object detected by the prohibited object detector; the human security officer failing to check the human patron for a potentially prohibited object detected by the prohibited object detector; the human security officer failing to maintain a predetermined post for a predetermined period of time; the human security officer failing to check the human patron using a predetermined check procedure; the human security officer failing to test operation of the prohibited object detector at a predetermined time; and the human security officer failing to test operation of the prohibited object detector using a predetermined test procedure.

The computer program code executed by the processor may further cause the processing device to: determine an actual position of the prohibited object detector based on the sensor data; and determine a position difference between the actual position of the prohibited object detector and an intended position of the prohibited object detector. The suboptimal manner of performance of the security check operations may comprise operating the prohibited object detector to detect the potentially prohibited object when the position difference is greater than a predetermined threshold.

The computer program code executed by the processor may further cause the processing device to determine a distance between portions of the prohibited object detector based on the sensor data. The suboptimal manner of performance of the security check operations may comprise operating the prohibited object detector to detect the potentially prohibited object when the distance is: greater than a maximum predetermined distance between the portions of the prohibited object detector; or less than a minimum predetermined distance between the portions of the prohibited object detector.

The present disclosure also introduces a system comprising: a digital video camera operable to output first sensor data; a ranging device operable to output second sensor data; an output device; and a processing device comprising a processor and a memory storing a computer program code which when executed by the processor causes the processing device to: generate a three-dimensional digital map of a security check environment based on the first and second sensor data; determine that the security check operations are being performed in a suboptimal manner based on the three-dimensional digital map; and in response to determining that the security check operations are being performed in a suboptimal manner, output alarm data to the output device to cause the output device to output an alarm signal indicative of the suboptimal manner in which the security check operations are being performed.

The security check environment may comprise at least one of: a prohibited object detector operable to detect a potentially prohibited object; a human patron who intends to walk through the prohibited object detector; an object carried by the human patron; and a human security officer. The prohibited object detector may comprise at least one of: a metal detector; an X-ray machine; a millimeter wave scanner; a trace portal machine; a frequency machine; a radio wave signal machine; and a weapons detection system.

The computer program code executed by the processor may further cause the processing device to: recognize the prohibited object detector in the three-dimensional digital map; recognize the human patron in the three-dimensional digital map; and determine a position of the human patron with respect to the prohibited object detector based on the three-dimensional digital map. Determining that the security check operations are being performed in a suboptimal manner may be further based on the determined position of the human patron with respect to the prohibited object detector.

The suboptimal manner of performance of the security check operations may comprise at least one of: the human patron walking around and not through the prohibited object detector; the human patron carrying an object through the prohibited object detector; the human patron walking through the prohibited object detector while positioning at least one hand outside of the prohibited object detector; the human patron walking through the prohibited object detector while carrying an object outside of the prohibited object detector; the human patron walking through the prohibited object detector while positioning at least one hand outside of a prohibited object detection area of the prohibited object detector; the human patron walking through the prohibited object detector while carrying an object outside of the prohibited object detection area; the human patron failing to walk back through the prohibited object detector after the human patron walked through the prohibited object detector and the prohibited object detector detected a potentially prohibited object; the human patron failing to present to the human security officer a potentially prohibited object detected by the prohibited object detector; the human security officer failing to check the human patron for a potentially prohibited object detected by the prohibited object detector; the human security officer failing to maintain a predetermined post for a predetermined period of time; the human security officer failing to check the human patron using a predetermined check procedure; the human security officer failing to test operation of the prohibited object detector at a predetermined time; and the human security officer failing to test operation of the prohibited object detector using a predetermined test procedure.

The computer program code executed by the processor may further cause the processing device to: determine an actual position of the prohibited object detector based on the three-dimensional digital map; and determine a position difference between the actual position of the prohibited object detector and an intended position of the prohibited object detector. The suboptimal manner of performance of the security check operations may comprise operating the prohibited object detector to detect the potentially prohibited object when the position difference is greater than a predetermined threshold.

The present disclosure also introduces a system comprising a sensor operable to output sensor data; an output device; and a processing device comprising a processor and a memory storing a computer program code which when executed by the processor causes the processing device to: determine an actual position of a prohibited object detector operable to detect a prohibited object based on the sensor data; determine a position difference between the actual position of the prohibited object detector and an intended position of the prohibited object detector; and, based on the position difference being greater than a predetermined threshold, output alarm data to the output device to cause the output device to output an alarm signal indicative of at least one of: the actual position of the prohibited object detector; the position difference; and existence of the position difference.

The sensor may comprise a ranging device. The sensor may also or instead comprise a digital video camera.

The sensor may be a first sensor, the sensor data may be a first sensor data, and the first sensor may comprise a digital video camera. The system may further comprise a second sensor comprising a ranging device operable to output second sensor data. The computer program code executed by the processor may further cause the processing device to determine the actual position of the prohibited object detector based further on the second sensor data.

The actual position of the prohibited object detector may comprise an actual distance between portions of the prohibited object detector, and the intended position of the prohibited object detector may comprise an intended distance between the portions of the prohibited object detector.

The foregoing outlines features of several embodiments so that a person having ordinary skill in the art may better understand the aspects of the present disclosure. A person having ordinary skill in the art should appreciate that they may readily use the present disclosure as a basis for designing or modifying other processes and structures for carrying out the same functions and/or achieving the same benefits of the embodiments introduced herein. A person having ordinary skill in the art should also realize that such equivalent constructions do not depart from the spirit and scope of the present disclosure, and that they may make various changes, substitutions and alterations herein without departing from the spirit and scope of the present disclosure.

The Abstract at the end of this disclosure is provided to comply with 37 C.F.R. § 1.72(b) to permit the reader to quickly ascertain the nature of the technical disclosure. It is submitted with the understanding that it will not be used to interpret or limit the scope or meaning of the claims.

What is claimed is:

1. A system comprising:
a sensor operable to output sensor data indicative of physical characteristics of a security check environment, wherein the security check environment comprises at least one of:
a prohibited object detector operable to detect a potentially prohibited object;
a human patron who intends to walk through the prohibited object detector;
an object carried by the human patron; and
a human security officer;
an output device; and
a processing device comprising a processor and a memory storing a computer program code which when executed by the processor causes the processing device to:
determine, based on the sensor data, that security check operations at the security check environment are being performed in a suboptimal manner; and
in response to determining that the security check operations are being performed in a suboptimal manner, output alarm data to the output device to cause the output device to output an alarm signal indicative of the suboptimal manner in which the security check operations are being performed.

2. The system of claim 1 wherein the prohibited object detector comprises at least one of:
a metal detector;
an X-ray machine;
a millimeter wave scanner;
a trace portal machine;
a frequency machine;
a radio wave signal machine; and
a weapons detection system.

3. The system of claim 1 wherein the sensor comprises a ranging device.

4. The system of claim 1 wherein the sensor comprises a digital video camera.

5. The system of claim 1 wherein:
the sensor is a first sensor;
the sensor data is a first sensor data;
the first sensor comprises a digital video camera;
the system further comprises a second sensor comprising a ranging device operable to output second sensor data indicative of the physical characteristics of the security check environment; and
determining that the security check operations are being performed in a suboptimal manner is further based on the second sensor data.

6. The system of claim 1 wherein:
the sensor is a first sensor;
the sensor data is a first sensor data;
the first sensor comprises a digital video camera;
the system further comprises a second sensor comprising a ranging device operable to output second sensor data indicative of the physical characteristics of the security check environment;
the computer program code executed by the processor further causes the processing device to generate a three-dimensional digital map of the security check environment based on the first and second sensor data; and
determining that the security check operations are being performed in a suboptimal manner is further based on the three-dimensional digital map.

7. The system of claim 1 wherein:
the computer program code executed by the processor further causes the processing device to:
generate a first digital model of the prohibited object detector based on the sensor data;
generate a second digital model of the human patron based on the sensor data; and
determine a position of the human patron with respect to the prohibited object detector based on the first and second digital models; and
determining that the security check operations are being performed in a suboptimal manner is based on the determined position of the human patron with respect to the prohibited object detector.

8. The system of claim 1 wherein the suboptimal performance of the security check operations comprises at least one of:
the human patron walking around and not through the prohibited object detector;
the human patron carrying an object through the prohibited object detector;
the human patron walking through the prohibited object detector while positioning at least one hand outside of the prohibited object detector;
the human patron walking through the prohibited object detector while carrying an object outside of the prohibited object detector;
the human patron walking through the prohibited object detector while positioning at least one hand outside of a prohibited object detection area of the prohibited object detector;
the human patron walking through the prohibited object detector while carrying an object outside of the prohibited object detection area;
the human patron failing to walk back through the prohibited object detector after the human patron walked through the prohibited object detector and the prohibited object detector detected a potentially prohibited object;
the human patron failing to present to the human security officer a potentially prohibited object detected by the prohibited object detector;
the human security officer failing to check the human patron for a potentially prohibited object detected by the prohibited object detector;
the human security officer failing to maintain a predetermined post for a predetermined period of time;
the human security officer failing to check the human patron using a predetermined check procedure;
the human security officer failing to test operation of the prohibited object detector at a predetermined time; and
the human security officer failing to test operation of the prohibited object detector using a predetermined test procedure.

9. The system of claim 1 wherein:
the computer program code executed by the processor further causes the processing device to:
determine an actual position of the prohibited object detector based on the sensor data; and
determine a position difference between the actual position of the prohibited object detector and an intended position of the prohibited object detector; and
the suboptimal manner of performance of the security check operations comprises operating the prohibited object detector to detect the potentially prohibited object when the position difference is greater than a predetermined threshold.

10. The system of claim 1 wherein:
the computer program code executed by the processor further causes the processing device to determine a distance between portions of the prohibited object detector based on the sensor data; and
the suboptimal manner of performance of the security check operations comprises operating the prohibited object detector to detect the potentially prohibited object when the distance is:
greater than a maximum predetermined distance between the portions of the prohibited object detector; or
less than a minimum predetermined distance between the portions of the prohibited object detector.

11. A system comprising:
a digital video camera operable to output first sensor data;
a ranging device operable to output second sensor data;
an output device; and
a processing device comprising a processor and a memory storing a computer program code which when executed by the processor causes the processing device to:
generate a three-dimensional digital map of a security check environment based on the first and second sensor data, wherein the security check environment comprises at least one of:
a prohibited object detector operable to detect a potentially prohibited object;
a human patron who intends to walk through the prohibited object detector;
an object carried by the human patron; and
a human security officer;
determine that the security check operations are being performed in a suboptimal manner based on the three-dimensional digital map; and
in response to determining that the security check operations are being performed in a suboptimal manner, output alarm data to the output device to cause the output device to output an alarm signal indicative of the suboptimal manner in which the security check operations are being performed.

12. The system of claim 11 wherein the prohibited object detector comprises at least one of:
a metal detector;
an X-ray machine;
a millimeter wave scanner;
a trace portal machine;
a frequency machine;
a radio wave signal machine; and
a weapons detection system.

13. The system of claim 11 wherein:
the computer program code executed by the processor further causes the processing device to:
recognize the prohibited object detector in the three-dimensional digital map;
recognize the human patron in the three-dimensional digital map; and
determine a position of the human patron with respect to the prohibited object detector based on the three-dimensional digital map; and
determining that the security check operations are being performed in a suboptimal manner is further based on the determined position of the human patron with respect to the prohibited object detector.

14. The system of claim 11 wherein the suboptimal manner of performance of the security check operations comprises at least one of:
the human patron walking around and not through the prohibited object detector;
the human patron carrying an object through the prohibited object detector;
the human patron walking through the prohibited object detector while positioning at least one hand outside of the prohibited object detector;
the human patron walking through the prohibited object detector while carrying an object outside of the prohibited object detector;
the human patron walking through the prohibited object detector while positioning at least one hand outside of a prohibited object detection area of the prohibited object detector;
the human patron walking through the prohibited object detector while carrying an object outside of the prohibited object detection area;
the human patron failing to walk back through the prohibited object detector after the human patron walked through the prohibited object detector and the prohibited object detector detected a potentially prohibited object;
the human patron failing to present to the human security officer a potentially prohibited object detected by the prohibited object detector;
the human security officer failing to check the human patron for a potentially prohibited object detected by the prohibited object detector;
the human security officer failing to maintain a predetermined post for a predetermined period of time;
the human security officer failing to check the human patron using a predetermined check procedure;
the human security officer failing to test operation of the prohibited object detector at a predetermined time; and
the human security officer failing to test operation of the prohibited object detector using a predetermined test procedure.

15. The system of claim 11 wherein:
the computer program code executed by the processor further causes the processing device to:
determine an actual position of the prohibited object detector based on the three-dimensional digital map; and
determine a position difference between the actual position of the prohibited object detector and an intended position of the prohibited object detector; and
the suboptimal manner of performance of the security check operations comprises operating the prohibited object detector to detect the potentially prohibited object when the position difference is greater than a predetermined threshold.

16. A system comprising:
a sensor operable to output sensor data;
an output device; and
a processing device comprising a processor and a memory storing a computer program code which when executed by the processor causes the processing device to:
determine an actual position of a prohibited object detector operable to detect a prohibited object based on the sensor data;
determine a position difference between the actual position of the prohibited object detector and an intended position of the prohibited object detector; and
based on the position difference being greater than a predetermined threshold, output alarm data to the output device to cause the output device to output an alarm signal indicative of at least one of:
the actual position of the prohibited object detector;
the position difference; and
existence of the position difference.

17. The system of claim 16 wherein the sensor comprises a ranging device.

18. The system of claim 16 wherein the sensor comprises a digital video camera.

19. The system of claim 16 wherein:
the sensor is a first sensor;
the sensor data is a first sensor data;
the first sensor comprises a digital video camera;
the system further comprises a second sensor comprising a ranging device operable to output second sensor data; and
the computer program code executed by the processor further causes the processing device to determine the actual position of the prohibited object detector based further on the second sensor data.

20. The system of claim 16 wherein:
the actual position of the prohibited object detector comprises an actual distance between portions of the prohibited object detector; and
the intended position of the prohibited object detector comprises an intended distance between the portions of the prohibited object detector.
